(19) United States
(12) Patent Application Publication
(10) Pub. No.: US 2021/0230854 A1
(43) Pub. Date: Jul. 29, 2021

(54) SELF CLEANING TOILET ASSEMBLY AND SHOWER ASSEMBLY

(71) Applicant: Jocelyn Bruno, Cibolo, TX (US)

(72) Inventor: Jocelyn Bruno, Cibolo, TX (US)

(21) Appl. No.: 16/751,087

(22) Filed: Jan. 23, 2020

(51) Int. Cl. E03D 9/00; B08B 1/00; B08B 1/04; B08B 3/08

(52) U.S. Cl. CPC E03D 9/002; B08B 1/002; E03D 9/005; B08B 1/008; B08B 3/08; B08B 1/04

(57) ABSTRACT

An automated toilet cleaning system is presented herein. The system includes at least one cleaning assembly communicatively connected to a control device. The cleaning assembly includes a positioning assembly and at least one cleaning end, wherein the positioning assembly has at least one positioning arm structured to movably dispose the cleaning end relative to the toilet. A cleaning solution chamber is included for retaining an amount of cleaning solution, and for fluidically delivering the cleaning solution chamber being to a nozzle or dispenser. When the automated toilet cleaning system is activated, the control device operates to movably position the positioning assembly to orient the cleaning end toward the toilet, and to direct a flow of water from and a flow of cleaning solution to and out of the cleaning end directed toward the toilet.

The present application is based on and a claim of priority is made under 35 U.S.C. § 119(e) to provisional patent application Ser. No. 62/765,206 filed on Aug. 20, 2018, the content of which is incorporated herein in its entirety by reference. The present application also is based on and a claim of priority is made under 35 U.S.C. § 119(e) to provisional patent application Ser. No. 16/383,580 filed on Apr. 13, 2019, the content of which is incorporated herein in its entirety by reference

### TECHNICAL FIELD

The present invention is directed to an automated toilet cleaning assembly and shower assembly. The automated toilet cleaning assembly functions to automatically clean a toilet using at least one or a plurality of an automated water nozzle or sprayer, and cleaning solution dispensers. The shower assembly includes a dedicated hot water tank and heater for producing its own hot.

### BACKGROUND

Many people truly dislike using public facilities, such as public restrooms, bathrooms or toilets, and often only do so out of necessity. One of the most common reasons for this dislike is due to a lack of cleanliness and the prolific spread of bacteria.

For instance, many public restrooms are cleaned by a cleaning staff member who may wipe down the counters, mop, and in some cases, clean the toilets. In many settings, public bathrooms are cleaned once per day or sometimes less than once per day, particularly public restrooms in parks and other outdoor locations

There is thus a need in the art for a system and method for automating the cleaning process in a bathroom, and particularly, the toilets. The proposed system should be easy to manufacture and easy to install in existing bathrooms or bathrooms of new construction. For example, a cleaning assembly can be mounted to an L-shaped frame installed to the wall behind the toilet which includes automated arms and/or rods to position one or more cleaning devices or apparatuses, such as a water or fluid distribution nozzle, cleaning solution dispenser, and air blower or drier in a manner to automatically clean and rinse the toilet when activated.

The present invention attempts to address the existing limitations in automated toilet and shower cleaning systems according to the principles and example embodiments disclosed herein.

### SUMMARY

In accordance with the present invention, the above and other problems are solved by providing an automated toilet cleaning assembly and shower assembly.

Accordingly, at least one embodiment of the present invention is directed to an automated cleaning system and method that can easily clean and sanitize toilets in any public bathroom. The automated cleaning system may, in some cases, be mounted to a L-shaped frame, or mounted base just above or otherwise proximate the toilet for manual or automatic activation.

In particular, the system includes one or more cleaning arm assemblies, such as, for example, a brushless cleaning arm assembly connected to a control device. Each of the cleaning arm assemblies include a positioning assembly and one or more cleaning devices or apparatuses, such as a spray nozzle, cleaning solution dispenser, etc. The positioning assembly may include a rotational or angular driving mechanism and/or linear driving mechanisms that can move in horizontal, vertical and three-dimensional directions in order to orient the cleaning apparatuses either proximate the toilet.

For instance, when the automated cleaning system is activated (e.g., by voice command, pressing an activation button, or automatically), the control device will operate to movably position the one or more cleaning arm assemblies via one or more positioning assemblies in order to orient the cleaning apparatus(es) toward the toilet. A flow of water and in some cases a cleaning solution will flow to the spray nozzles and/or cleaning solution dispensers toward the toilet. The spray nozzles can be used to spray water and/or cleaning solution on the toilet for rinsing and washing. After the system has stopped using the spray nozzles, in at least one embodiment, a drier can be used to blow hot or warm air onto the toilet for purposes of facilitating drying the toilet.

At the end of the cleaning cycle, the positioning assemblies can reposition the arms against the wall or frame and away from the toilet. This allows the toilet to be used again without obstruction from the cleaning system of the present invention.

Yet another embodiment of the present invention includes a shower assembly capable of maintaining and producing its own hot or temperature-controlled water. The shower assembly of at least one embodiment also includes an oversized or enlarged overhead shower head or sprayer.

A user panel allows a user to select a desired temperature for the water, for example, via a rotational dial, and a water pressure, for example, via selection button. In some embodiments, the system can deliver up to four or more different water pressures.

Both the automated toilet cleaning system and the shower assembly can be easily installed in commercial or public restrooms, including office buildings, airports, service stations, gas stations, hospitals, parks, etc. These and other objects, features and advantages of the present invention will become more apparent when the drawings as well as the detailed description are taken into consideration.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 is a partial front perspective view of another embodiment of the automated toilet cleaning system as disclosed herein.

FIG. 2 is a partial interior view of a toilet bowl with a cleaning apparatus disposed therein.

FIG. 3 is a front perspective view of yet another embodiment of the automated toilet cleaning system as disclosed herein.

FIG. 4 is a partial side plan view of the base and support structure as disclosed in accordance with at least one embodiment of the present invention.

FIG. 5 is a rear plan view of the base disclosed in FIG. 4.

FIG. 6 is a top view of the base and partial view of the support structure as disclosed herein.

FIG. 7 is a partial front view of some components of the shower assembly as disclosed in accordance with at least one embodiment herein.

FIG. 8 is a front view of some components of the shower assembly as disclosed in accordance with at least one embodiment herein.

FIG. 9 is a top view of the toilet and angled tray as disclosed in accordance with at least one embodiment of the present invention.

FIG. 10 is a side view of the toilet and angled tray as disclosed in accordance with at least one embodiment of the present invention. Notably, the angle of the angled tray is exaggerated for purposes of discussion only.

FIG. 11 is a side view of the shower assembly as disclosed in accordance with yet another embodiment of the present invention.

FIG. 12 is a front view of the shower assembly as disclosed in accordance with at least one embodiment of the present invention.

FIG. 13 is a schematic representation of the shower head and shower assembly as disclosed in accordance with at least one embodiment of the present invention.

FIG. 14 is a schematic representation of some components of the shower assembly as disclosed in accordance with at least one embodiment herein

FIG. 15 is a schematic representation of some components of the shower assembly as disclosed in accordance with at least one embodiment herein.

Like reference numerals refer to like parts throughout the several views of the drawings provided herein.

### DETAILED DESCRIPTION

This application relates in general an article of manufacture for providing an automated toilet cleaning assembly.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “user” and “individual” refers to an entity, e.g. a human, that uses a toilet according to the present invention in order to bring about a desired effect or outcome. For such a user, the terms “user” and “individual” may be used herein interchangeably.

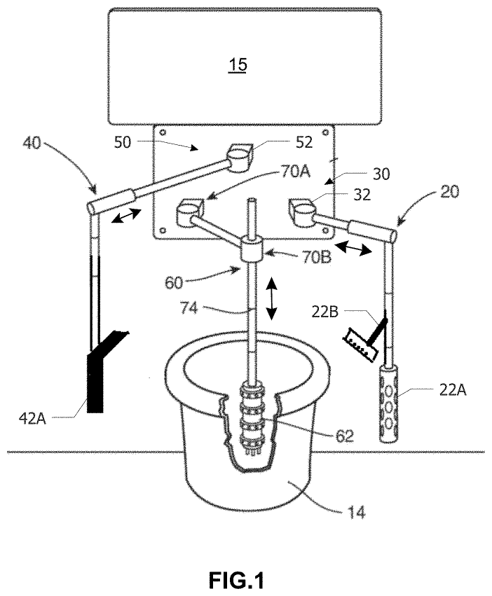

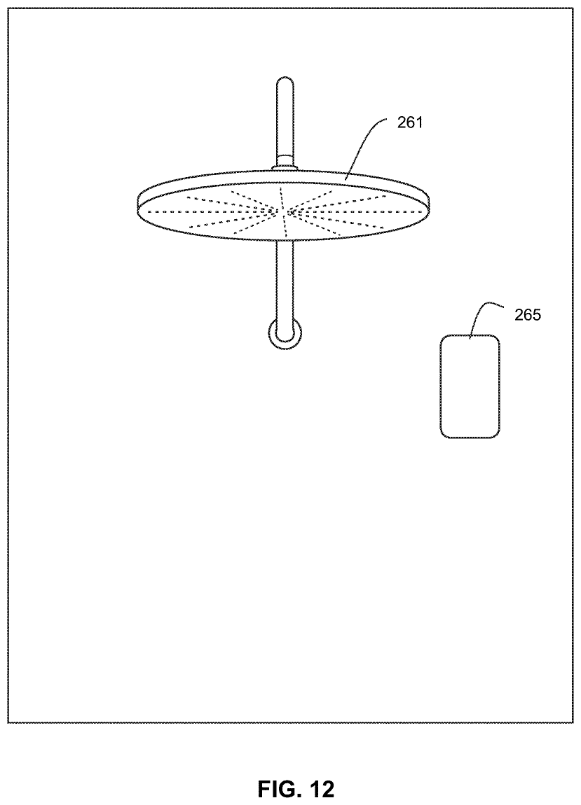

In general, the present disclosure relates general an article of manufacture for providing an automated toilet cleaning assembly and shower assembly. As shown in the accompanying drawings, and with particular reference to FIGS. 1 through 8, at least one embodiment of the present invention is directed to an automated toilet and/or bathroom cleaning system, generally referenced as 10. With reference to FIGS. 12 though 15, additional or alternative embodiments of the present invention may also include a shower assembly, generally referenced as 100.

Specifically, as will become apparent from the description provided herein, the toilet or bathroom cleaning assembly or system 10 can be easily installed in any residential, commercial or industrial environments, including public restroom, for example, in airports, service stations, office buildings, hospitals, hotels, etc. Activation of the cleaning system 10 will trigger a cleaning cycle and will cause a number of cleaning devices or apparatuses, such as water nozzles, jet sprayers, and cleaning solution dispensers, to automatically spray and/or otherwise clean the surfaces of a toilet, and in some cases, surrounding surfaces, without manual scrubbing or intervention.

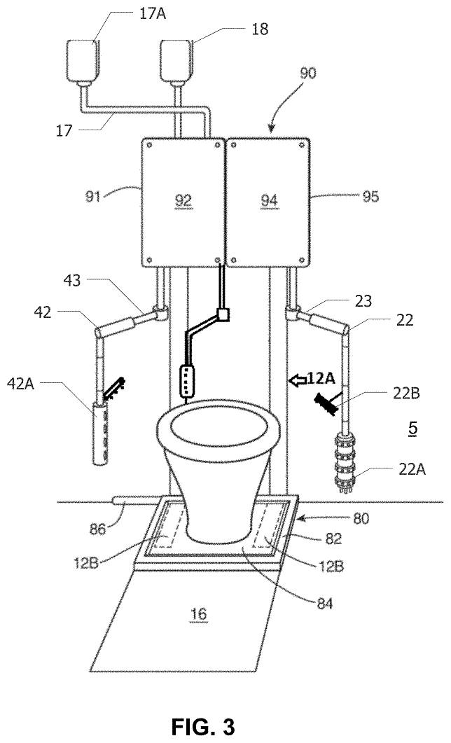

In particular, with reference to FIGS. 1-3, the automated cleaning system 10 of at least one embodiment includes a number of components mounted to a support structure 12. The support structure 12 shown in FIG. 3 is a frame that can be easily installed in new bathrooms or retrofitted into existing bathrooms without the need for extensive reconstruction. For example, as will be described herein, the frame may be mounted to the floor proximate the bottom of the toilet and extend up above the toilet.

Accordingly, the support structure 12 may extend directly above or proximate a toilet 14, such that, during a cleaning process, surfaces of the toilet 14 can be easily reached and cleaned. In one embodiment, the support structure 12 or frame include a metal or other rigid structure which allows at least some of the components described herein to be mounted, either directly or indirectly. The support structure 12 may include a plurality of mounting holes which allow the support structure 12 to be attached to a floor, wall or other surface via a plurality of screws, nails, or other fasteners.

In other embodiments, the support structure 12 may be in the form of a base plate, which can be mounted directly to a wall 5, ceiling or other support surface within a bathroom. It is also contemplated that, in at least one embodiment, the cleaning system 10 may be installed or mounted in a number of different manners, some of which may include a mounting base or frame while others may not. As an example, at least some of the components of the cleaning system 10 may be mounted directly to the floor, wall or other support surface, including wall studs, beams, etc.

In any event, the cleaning system 10 of at least one embodiment includes a control device or assembly 15. The control device or assembly 15 includes various computer devices, components and electronics, including, for example, one or more computer processors, memory, and/or other control circuits and logic to implement the system and methods as disclosed in accordance with at least one embodiment of the present invention. For example, the control device 15 may be communicative with one or more activation devices to activate or start a cleaning process or cycle, one or more cleaning arm assemblies or positioning assemblies to move, activate and operate one or more water or fluid nozzles, cleansing solution distribution, air (or other) driers, etc. Particularly, the cleaning system 10 of at least one embodiment includes at least one cleaning arm assembly 20, 40 operationally communicative with the control device 15. Each cleaning arm assembly (e.g., first cleaning arm assembly 20 and second cleaning arm assembly 40) includes a positioning assembly (e.g., first positioning assembly 30 and second positioning assembly 50) and at least one cleaning end or cleaning apparatus 22A, 22B, 42A. The first and second positioning assemblies 30, 50 are configured to position the corresponding cleaning arm assembly 20, 40 and cleaning apparatus 22A, 22B, 42A, in proximity to the toilet 14, directed toward the toilet 14, and in some cases.

Furthermore, the cleaning assemblies 20, 40, and in particular, the positioning assemblies 30, 50 thereof, include a positioning arm 32, 52 to which the cleaning end or cleaning device 22, 42A is attached. Accordingly, as the positioning arm(s) 32, 52 move, the cleaning devices 22, 42A also move, for instance, with the movement of the corresponding positioning arm 32, 52. In one exemplary embodiment, the positioning arms 32, 53 may be at least partially telescopic in that an extension arm 33, 53 may extend or retract. In other embodiments, regardless of whether the positioning arm 32, 52 includes a telescopic extension arm 33, 53, the entire positioning arm 32, 52 may move, for example, in an upward and/or downward direction, as is described herein.

Still referring to FIGS. 1-3, the positioning assemblies 30, 50 of at least one embodiment include rotational or angular drive components, such as motor or driver 32, 52 configured to angularly or rotationally drive or move the corresponding cleaning arm assembly 20, 40 in a rotational or angular direction relative to the support structure 12 or relative to the toilet 14. For example, positioning assembly 30 is structured to rotationally drive or position corresponding arm assembly 20 at least partially around the toilet 14. This allows cleaning apparatuses 22A and 22B to move about the exterior or the toilet 14 for purposes of cleaning, as disclosed herein. Similarly, positioning assembly 40 is structured to rotationally drive or position corresponding arm assembly 40 at least partially around or about the exterior of the toilet 14. This allows cleaning apparatuses 42A to move about the exterior or the toilet 14 for purposes of cleaning, as disclosed herein. Accordingly, positioning assemblies 30, 50 may include a number of gears, motors, shafts, or other drive assemblies capable of facilitating the angular or rotational movement of the corresponding arm assembly. In some embodiments, the arm assemblies 20, 40 may move approximately one hundred and eighty (180) degrees about the exterior of the toilet, although other rotational distances or angles are contemplated.

Furthermore, still referring to FIGS. 1-3, the arm assembly 20, 40 of at least one embodiment includes a biased arm section, represented as 22, 42, respectively. The biased arm section is linearly extendable toward and away from the mounted end 21, 41 of the corresponding arm assembly 20, 40.

For instance, a spring or other biasing device may be mounted inside and between biased arm section 22 and shaft or arm 23, wherein the shaft or arm 23 is linearly fixed and biased arm section 22 is linearly movable. Specifically, biased arm section 22 may be normally biased (i.e., in a relaxed state) toward the mounted end 21 or shaft or arm 23. However, when an outward force (e.g., in a direction away from the end 21) greater than the normal biasing force is exerted upon the biasing device, the biased arm section will extend outward and away from end 21.

Similarly, biased arm section 42 is movable in a linear direction toward and away from the end 41 via a similar biasing device (not shown), such as a mechanical spring or other device capable of facilitating similar linear movement. For instance, a spring or other biasing device may be mounted inside and between biased arm section 42 and shaft or arm 43, wherein the shaft or arm 43 is linearly fixed and biased arm section 42 is linearly movable. Specifically, biased arm section 42 may be normally biased (i.e., in a relaxed state) toward the mounted end 41 or shaft or arm 43. However, when an outward force (e.g., in a direction away from the end 41) greater than the normal biasing force is exerted upon the biasing device, the biased arm section will extend outward and away from end 41.

Still referring to FIGS. 1-3, the automated toilet cleaning system 10 of at least one embodiment of the present invention includes at least one fluid input, generally referenced as 17, for receiving a flow of fluid, such as water, from a water source 17A. The input 17 is fluidically interconnected, either directly or indirectly, to one or more of the cleaning ends e.g., 22A, 22B such that water or fluid flowing into or through the input 17 can controllably flow to and be released or dispensed from one or more of the cleaning apparatuses 22A, 22B.

It should be noted that the water or fluid input 17 can be directly connected to the one or more cleaning arm assemblies 20 via one or more hoses, pipes or other connections. In the illustrated embodiment, the water or fluid may flow into through input 17, for example, via a water source 17A (e.g., water source of the building, restroom or structure) by one or more pipes, connectors, tubes, conduits, etc. Additional pipes, tubes, hoses, etc. can flow from the input 17 to the cleaning arm assemblies 20, for example, internally through the various components of the positioning assemblies 30 or externally (not shown).

It should also be noted that the cleaning system 10 of at least one embodiment may have a plurality of water or fluid inputs 17, for example, for hot and cold-water input. The various cleaning arm assemblies 20 may share the same water inputs 17 or, in some cases, may have independent inputs 17.

Furthermore, at least one embodiment of the present invention also includes a cleaning solution chamber 18 for retaining an amount of cleaning solution, such as soap, disinfectant, bleach, water, mixture, etc. In some embodiments, the invention includes a cleaning solution flow meter connected to the chamber and structured to monitor the level of cleaning solution therein. For example, if the level of cleaning solution drops below a certain predetermined volume or amount (e.g., 25%), the system can add water to the chamber to increase the level.

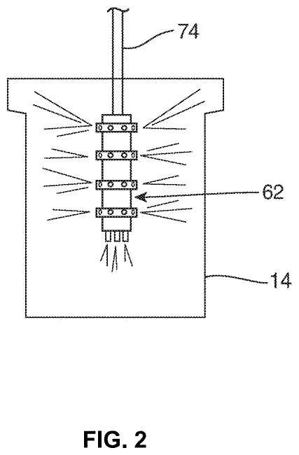

In any event, the cleaning solution chamber 18 is fluidically interconnected, either directly or indirectly, to one or more of the cleaning ends 22A, 22B such that a cleaning solution flowing from the chamber 18 can controllably flow to and be released or dispensed from one or more of the cleaning ends or devices 22. With reference now to FIGS. 2 and 3, at least one embodiment of the present invention includes an inner bowl cleaning arm assembly, referenced as 60, with an inner bowl cleaning apparatus 62 connected thereto. The apparatus 62 may be in the form of a spray nozzles, cleaning solution dispensers, or any combination thereof. In particular, the inner bowl cleaning arm assembly 60 includes a positioning assembly 70A, 70B to movably position the apparatus 72 into and out an interior of the toilet 14, such as the toilet bowl.

For example, positioning assembly 70A of at least one embodiment interconnects with an end of the arm assembly 60 and is structured to angularly position the arm assembly 60 relative to the support structure 12 or toilet 14. In one embodiment, the angular positioning may be along a horizontal plane such that positioning assembly 70A positions the cleaning apparatus 62 above the toilet bowl by rotating the arm assembly 60 horizontally, while positioning assembly 70B is configured to vertically position the cleaning apparatus 62 into and out of the toilet bowl.

In at least one embodiment, positioning assembly 70 includes a motor and corresponding component(s) such as one or more shafts, gears, etc. to accomplish the angular or rotational movement. Positioning assembly 70B may include a motor, pulleys, gears, etc. configured to drivingly move shaft 74 up and down, or otherwise in a vertical direction into and out of the toilet bowl.

FIG. 2 represents the cleaning apparatus 62 of at least one embodiment disposed on the interior of the toilet bowl and spraying fluids, such as water and cleaning solution therein during a cleaning cycle.

In addition, with reference now to FIGS. 3 through 6, at least one embodiment the present invention may include a base in the form of an angled floor surface, tray or collection plate, referenced as 80. In particular, the surface 80 is positioned below the cleaning arm assemblies 20, 40, 60 and provided a surface in which the water and fluids sprayed by the system 10 can be collected and drained.

For instance, in at least one embodiment, the base includes an outer frame section 82 and an inner recessed surface 84. The water or fluid sprayed or produced by the present invention can be collected or otherwise can fall onto the base 80, and in particular, into the recessed inner surface 84 thereof. The base 84 may include a drain (not shown) through which the water or fluids can be directed. A drainpipe 86 will then drain the water or fluid, for example, to the main bathroom drain lines. In some embodiment, the base 80 includes an angled surface such that the fluid will be directed toward the drain.

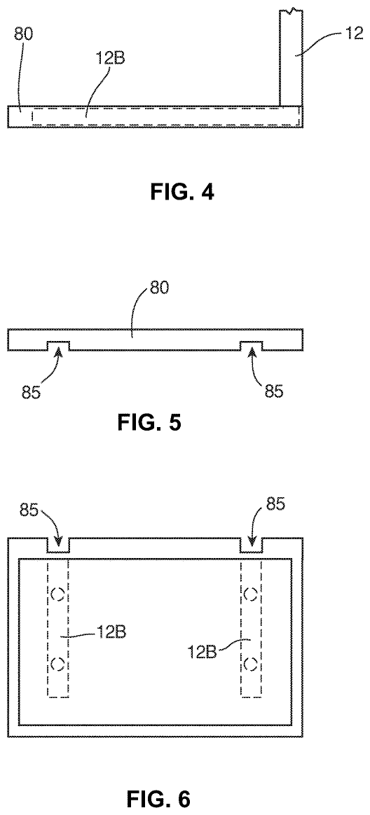

Additionally, frame 12 of at least one embodiment may be secured to the floor and/or wall adjacent the toilet. This allows the system 10 to be easily installed in existing bathrooms or in new construction bathrooms. For example, with reference to FIGS. 2 and 4, the frame 12 includes an upper mounting section 12A and one or more feet or bases 12B. The cleaning arm assemblies 20, 40, 60 and other components of the present invention may be mounted to the upper mounting section 12A of the frame 12. The base or feet 12B of the frame 12 may form an L-shape, and provide stability for the frame 12. For instance, the base or feet 12B can be secured or bolted directly to the floor via bolt holes, while the upper mounting area extends upward generally above the toilet. The upper mounting area of the frame 12 can in some case also be fixed, for example, by attaching it to the wall or wall studs via screws, bolts, etc.

With reference to FIGS. 4, 5 and 6, the base plate 80 of at least one embodiment is disposed in an at least partially overlying relation with the base or feet 12B of the frame 12. In this manner, once the frame 12 is secured to the floor, the base plate 80 is positioned on top of the feet 12B. Corresponding channels 85 may be provided in the base plate 80 to receive the feet 12B of the frame.

Furthermore, the cleaning system 10 of at least one embodiment further includes an activation device 16 that is structured to activate a cleaning cycle of the automated toilet cleaning system 10 of the present invention. It should be noted that in some cases, the activation device 70 of at least one embodiment is separate and independent of a toilet flush sensor (e.g., a sensor which activates a toilet flush when the user vacates the vicinity). In other words, in at least one embodiment, the cleaning system 10 must be separately activated via activation device 16, and will not automatically activate after every toilet flush. In other embodiments, however, the cleaning system 10 can activate automatically after every toilet flush, after a certain number of toilet flushes, at a set day and time, etc.

With reference to FIG. 3, in at least one embodiment, the activation device 16 may be in the form of a weight sensor, for example, on a mat, disposed immediately in front of the toilet 14. The weight sensor may be configured to recognize when a force or weight above a predetermined threshold (e.g., above 30 pounds) is present on the mat. If so, then system 10 will not activate a cleaning cycles, as this would indicate that a patron is still present in the stall. Once the patron leaves, and the weight is removed from the sensor, mat or activation device, a cleaning cycle may begin.

In other cases, a user can selectively activate the cleaning system 10 via activation device 16, which may be in the form of a button, switch, lever, pull cord, etc. Activation device 70 can, in some cases, be voice activated, such that voice command from the user or other individual can activate a cleaning cycle.

In any event, when a cleaning cycle is activated in accordance with at least one embodiment of the present invention, the control device 15 will operate to movably position one or more of the cleaning arm assemblies 20, 40, 60 and/or one or more of the corresponding cleaning apparatuses 22, 42, 62 thereof in order to orient the cleaning apparatuses 22, 42 toward the toilet 14. A low of water and/or cleaning solution may be directed from the input 17 to one or more of the cleaning ends 22, 42 toward the toilet.

For example, in one embodiment, one of the cleaning arm assemblies, such as the first cleaning arm assembly 20 may provide brushless, fluid cleaning in that the one or more cleaning apparatuses 22A, 22B of the first cleaning arm assembly 20 includes spray nozzles or other devices configured to spray or otherwise dispense water, fluids, and/or cleaning solution toward the toilet.

Accordingly, when the first cleaning assembly 20 is activated, the corresponding positioning assembly 40 can movably dispose the arm assembly 20 in an angular or rotational movement while the spacer arm 25 maintains contact the with external surface of the toilet. The biased arm section 22 can extend and retract as the arm assembly moves around the toilet 14. The cleaning apparatus 22A, 22B can spray water and cleaning solution onto surfaces if the toilet, including the external surfaces, the top edge (e.g., where a patron may sit), and/or inside the toilet.

If the system 10 includes an inner bowl arm assembly 60, for example, as illustrated in FIGS. 1 and 2, the control device 15 may activate the corresponding positioning assembly 70A, 70B in order to horizontally and vertically orient the corresponding cleaning apparatus 62 at least partially inside the bowl. In the illustrated embodiment, the cleaning apparatus 62 includes a plurality of spray heads or spray nozzles that are configured to direct a flow of water and/or cleaning solution on to the interior surface of the toilet bowl for cleaning.

In some embodiment, another cleaning arm assembly 40 may be included in order to provide hot or warm air onto the toilet surface(s). For example, cleaning apparatus 42, as illustrated in FIG. 1, may include an air blower which is configured to direct a flow of air, preferably warm or hot air, onto the surfaces of the toilet. This is generally done after the system 10 has sprayed water or cleaning solutions, for example, via one or more of the other arm assemblies 20, 60.

It should be noted that the various cleaning arm assemblies 20, 40, 60 may be activated at the same time or different times independent of one another.

It should also be noted that the toilet 14 of at least one embodiment of the present invention smooth surfaces, lacks a lifting seat, and in some embodiments also lacks a cover. In some cases, the toilet may be constructed of a single mold or a piece in order to minimize or eliminate hard-to-reach surfaces, for purposes of cleaning. For instance, conventional toilets or commodes often have many grooves, cracks, creases, exposed screws, etc. that are difficult to clean or keep clean.

The toilet 14 or commode of at least one embodiment the present invention is more pleasant to the eye and easier to clean. With reference to FIG. 3, a cover 90 or cabinet assembly of at least one embodiment is illustrated. The cover 90 can cover or hide at least some of the components of the cleaning system 10. For example, the cover 90 of at least one embodiment may include two pivoting cabinet doors 92, 94 that pivot open and closed on the outermost ends 91, 95. Particularly, FIG. 3 illustrates the cover 90 disposed in the closed position wherein at least some of the cleaning system 10 is hidden there behind. During operation of the cleaning system 10, for example, when the cleaning system 10 is operatively spraying water, cleaning solution or scrubbing the toilet, the cover or cabinets 90 of at least one embodiment may be disposed in an open orientation, thereby exposing the cleaning system 10 similar to that shown in FIG. 3. For example, the left cabinet door 92 may pivot open via a hinge or other like device on the left edge 91, whereas the right door 94 may pivot open via a hinge of other like device on the right edge 95. Once the cleaning cycle is over, or otherwise when the cleaning system 10 is not in use, the cabinet doors 92, 94 may pivot into the closed orientation. Other covers 90 are also contemplated, including retractable doors, sliding doors, folding doors, etc. In other embodiments the cabinet 90 may conceal some of the components of the present invention, such as the control device 15, at least some of the positioning devices, etc. even during operation of a cleaning cycle.

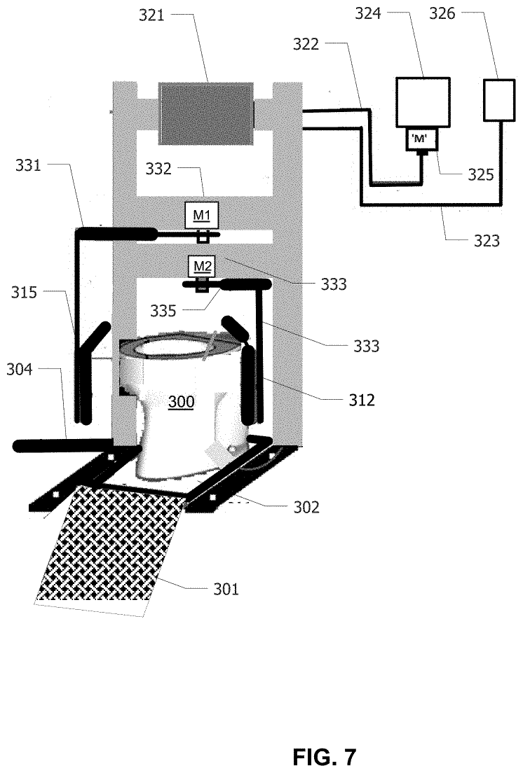

FIG. 7 is a schematic representation of some components of the automated cleaning apparatus for cleaning an exterior of toilet 300 as disclosed in accordance with at least one embodiment herein. The automated cleaning apparatus includes an L-frame 320 that is attached to a rear wall as well as the floor to position the cleaning apparatus around toilet 300. Control device 321 may be attached to frame 320 and connected to all other devices to control their activation and operation. Motor M1 332 and motor M2 333 are attached to frame 320 and cause sprayer 312 and dryer head 315 to move around toilet 301. Floor mat 302, drain line 304, and drainage tray 303 are also shown and operated as discussed above in reference to FIGS. 3-6.

Motor M1 322 connects an arm 331 to dryer head 315 and causes arm 331 to rotate in a 180° arc causing dryer head 315 to move around toilet 300. A heated air line, not shown, is coupled to arm 331 to deliver the heated air to dryer head 315 during operation.

Motor M2 333 connects an arm 332 to sprayer 312 and causes arm 332 to rotate in a 180° arc causing sprayer 312 to move around toilet 300. Arm 332 may also include spring mechanism 335 to cause an upper member containing the spring mechanism to vary its length. The spring mechanism 335 provides tension needed to keep sprayer 312 at a predefined distance with toilet 300 as is rotate about the toilet. In this embodiment, sprayer 312 may include a roller that rotates while dispensing cleaning solution and water while remaining in contact with the exterior surface of toilet 300.

A hot water line 323 and a cleaning solution line 322 are coupled to arm 332 to deliver these liquids to sprayer 312 during operation. The hot water line 323 is connected to hot water source 326 that may consist of a heating element or simply a connection to a hot water line in the building. The cleaning solution line 322 is connected to a reservoir 324 via pump 325, wherein the pump 325 generates sufficient pressure within cleaning solution line 322 to deliver the solution to sprayer 312 during operation.

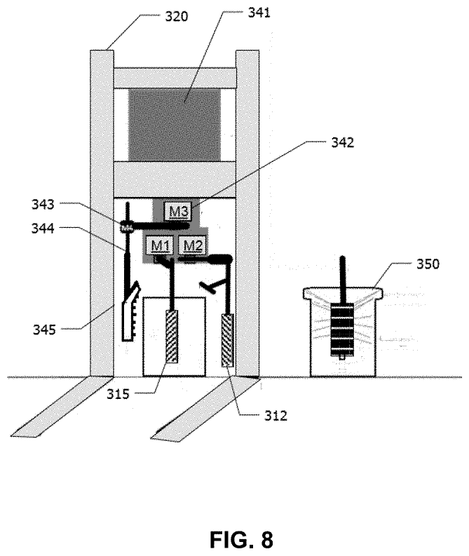

FIG. 8 is a schematic representation of some components of the automated cleaning apparatus for cleaning an interior of toilet 300 as disclosed in accordance with at least one embodiment herein. Frame 320 is shown with motors M1 332 and M2 333 connected to their respective dryer head 315 and sprayer 312 as discussed above in reference to FIG. 17. Motor M3 342 has been added and is coupled to arm 344 causing arm 344 to rotate in an approximate 90° arc causing bowl scrubber 345 to move above a bowl within toilet 300. Hot water line 323 and cleaning solution line 322, not shown, are coupled to arm 344 to provide cleaning solutions to bowl scrubber 345 in a similar manner as discussed above in reference to sprayer 312 of FIG. 7. Arm 344 contains motor M4 343 with a rotating shaft to cause bowl scrubber to rotate while in contact with an inside surface of toilet 300 within the bowl. Control device 321 operates motors M3 342 and M4 343 during cleaning to move bowl scrubber 345 from its retracted position to above and then within the bowl of toilet 300 as well as causes scrubber 345 to rotate and clean the inside of toilet 300. Control device 321 also enables and disables the flow of hot water and cleaning solutions thru lines 322, 323 for cleaning. Operation of scrubber 345 within a bowl 350 is shown. This cleaning occurs in a similar manner as described above in reference to FIG. 2.

Because of the varying sizes of toilets that may be cleaned using the disclosed system, dryer head 315, sprayer 312, and scrubber 345 are attached to their respective arms using one or more of a plurality of mounting holes permitting the devices to positioned at a desired height. Additionally, the automated cleaning system operates best when a seat to toilet 300 is permanently attached to the bowl rather than be liftable to add in the insertion and extraction of scrubber 345 during cleaning.

During a typical cleaning sequence, Motor M3 342 causes arm 344 to move through a 90° arc to place scrubber 345 above the bowl of toilet 300. Motor M4 343 causes it shaft to lower scrubber into the bowl and begins rotating. Motor M4 343 moves the arm to a few degrees in each direction to cause scrubber 345 to come into contact with the bowl while rotating. Control device 321 releases cleaning solution and hot water either together or in sequence while the scrubber is in contact with the bowl for cleaning. This cleaning process typically ends with a water only rinse of hot water. An alternating sequence of cleaning solution and hot water may be repeated any number of times to ensure all matter has been loosened and rinsed off the toilet 300. Motor M4 343 uses it shaft to lift scrubber 345 into its retracted position and then motor M3 342 causes arm 344 to rotate back to its retracted position, and thus moving scrubber 345 away from toilet 300.

Once the interior of toilet 300 has been cleaned, motor M2 333 causes its arm to move through its arm upon direction of control device 321 while cleaning and hot water are dispensed in a manner similar to the interior above. Multiple passes around toilet 300 by sprayer 312 may occur to clean the exterior of the toilet. Motor M1 332 causes its arm to move under the direction of control device 321 moving dryer head 315 to enable high pressure air to be directed towards toilet 300 causing any remaining moisture to be removed. Control device 321 retracts each of these two arms into a safe position once their respective task has been completed.

Control device 321 may being the above cleaning process by determining that no one is standing on mat 301, activating any light or display to indicate the stall is not available during cleaning. An automated latch may also be activated by control device 321 to deter individuals from entering during cleaning. Once the cleaning process ends, control device 321 may disengage the latch and disable any lights or displays to indicate that toilet 300 is available for use.

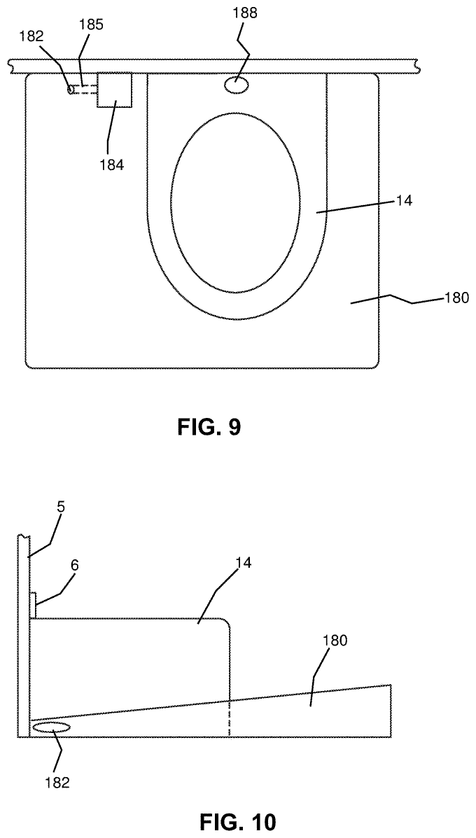

FIGS. 9 and 10 represent side schematic views of the toilet 14 and bottom base or tray 180 in accordance with one embodiment. For instance, the tray or base 180 may include downward sloped surface directed toward a drain 182. It should be noted that the angle shown in FIG. 10 is exaggerated in order to allow the viewer to realize that the tray or floor surface 180 is angled toward the drain 182 such that all fluids that contact the floor surface 182 will naturally flow down toward the drain 182. The toilet 14 may, in some embodiments, be mounted to or near wall 5, to which the cleaning assemblies are also mounted, either directly or indirectly. Furthermore, a drain pump 184 may be connected to the drain 182 via piping 185 beneath the floor or try surface to direct all captured fluids to the drain. Toilet 14 may also include sensing device 88 to trigger a flush, for example, when a user has left the vicinity of the device 88.

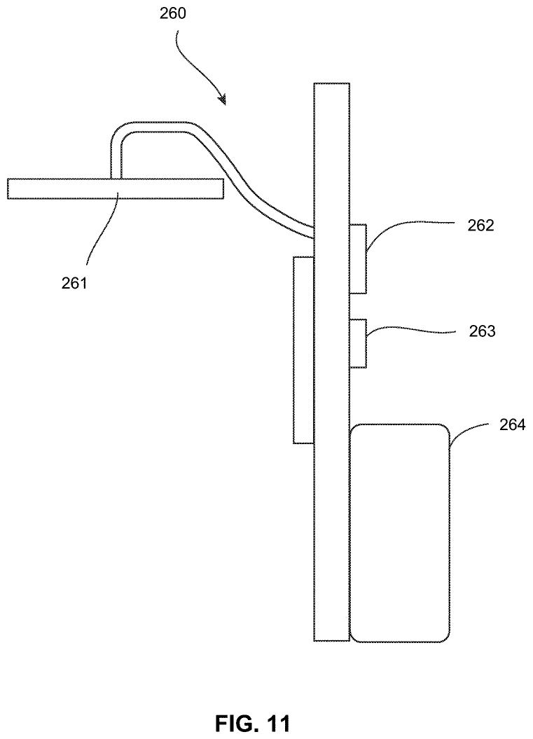

With reference now to FIGS. 11 through 14, a shower assembly 260 is illustrated. In particular, and with reference to FIGS. 11 and 12, shower assembly 260 includes a shower head 261 installed or otherwise mounted in a shower area. For instance, the shower head 261 may be mounted to a wall 7 or otherwise mounted or disposed on one side of the wall 7, i.e., the side of the all that defines the area within which a user will shower.

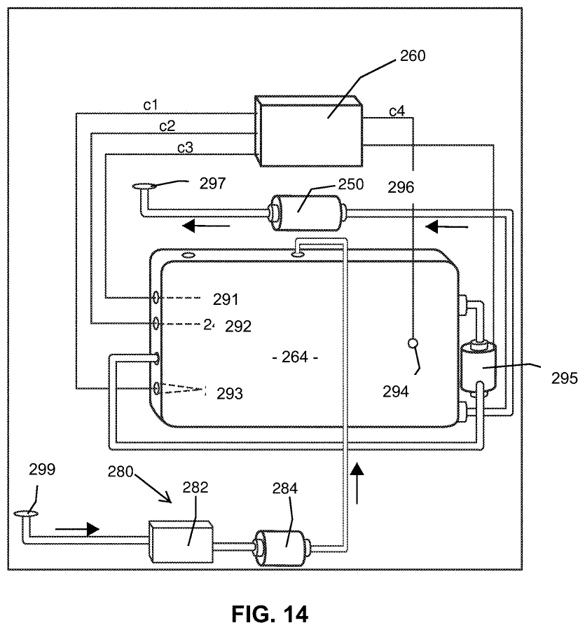

On the other side of the wall 7, or otherwise in a different location, the shower assembly 260 includes a plurality of other components, including, for example, a water tank 264, a water pump 263 and a control device 262. For instance, with reference to the schematic illustrated in FIG. 14, the inside of the shower head 261 is illustrated as being fluidically interconnected to the pump 263, which is fluidically interconnected to the water tank 264. Also illustrated is a user panel 170. In at least one embodiment, the shower head 261 is an enlarged shower head having a width of approximately two (2) feet, and a length of approximately two (2) feet. Other dimensions larger or smaller are contemplated within the full spirit and scope of the present invention.

Furthermore, the shower head 261 of at least one embodiment includes a matrix or grid of a plurality of outlets that deliver water at user-specified pressures. For instance, the shower head 261 includes an inlet or distribution hub 266 to which the water is initially provided. From the distribution hub 266, water is distributed evenly to the plurality of outlets or water jets.

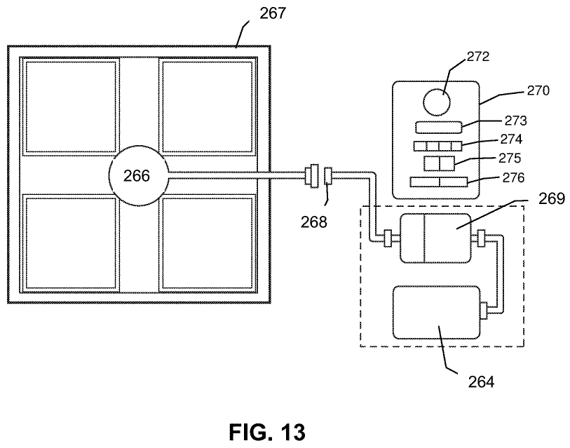

Still referring to FIG. 13, the user panel 270 of at least one embodiment is a low voltage powered or electronic panel mounted within easy reach of the user within the showering area or just outside of the showering area. The user panel 270 is communicative with the control device 262. The control device 262 may be mounted on the opposite side of the wall 7 as the user panel 270, or in some cases, a distance away. In this manner, communication between the user panel 270 and the control device 262 may be via wireless communication (e.g., WiFi, Bluetooth, etc.) or a wired connection.’

The water pump 263 includes a multiple speed impeller head, for example, but not limited to a four-speed impeller head, which allows the pump to operate at different pressure levels. In other words, the water pump can deliver water to the shower head 261 at different water pressures, selected by the user via the user panel 270.

The water tank 264 allows the system to produce its own hot or temperature-controlled water supply. For instance, the temperature-controlled water tank 264 can be mounted on the opposite side of the wall 7, along with the water pump 263.

With reference to the schematic of the user panel 270, a knob 272 or other selector can be used to manually select the water temperature. Upon turning the knob 272 or other selection device (e.g., buttons), display screen 273 displays the selected temperature, for example, in Celsius or Fahrenheit. Selection device 274 allows the user to select, via push button, roller, knob or the like, a water pressure level. In the exemplary embodiment, four different selection buttons are shown, one for a different water pressure level. Selection 275 provides an ‘ON’ or ‘OFF’ selection, to activate or deactivate the shower assembly 100. When the ‘ON’ is activated, water will pump from the tank 140, through the pump 150, to the shower head 261 (e.g., to the distribution hub 266, then to the plurality of outlet jets) at the selected temperature and selected water pressure. Display 276 shows the current status of the shower assembly 100, for example, either ‘RUN’ or ‘STANDBY.’

Referring now to FIG. 14, the holding tank 264, pump 263 and control device 262 are shown as being installed on the reverse side of the wall 7. In particular, holding tank 264 is configured to retain an amount of water and heat or otherwise control the temperature of the water for use in the shower. In this manner, the shower assembly 100 of at least one embodiment includes a separate and dedicated hot water tank to minimize or eliminate running out of hot water during a shower.

For instance, reference 291 represents a float switch or other sensor that operates to mechanically turn the water intake off when the water level in the tank 240 reaches a predetermined top or maximum level. When the float switch 241 drops to or below a predetermined low level, the water intake will again turn on to fill the tank 264. This operates similar to the action of flushing a toilet.

Further, reference 292 represents another switch or sensor, such as a float switch, that will trigger an alarm or notification to the user in the shower that the water level in the tank 264 has reached a predetermined level, for example, when the water level in the tank 264 is half or less than half, the alarm or notification to the user will indicate that the temperature controlled water is almost empty and to leave the shower. The alarm or notification could also indicate a malfunctioning on switch 291.

Moreover, at least one embodiment also includes a recirculation pump 295 to recirculate water in the tank 264. This can help with maintaining a stable temperature in the tank 264. It should be noted that a heating element 246 may be disposed within the tank 264 that includes a sufficient amount of power to heat the water in the tank 264 to a selected temperature level. The size and power of the heating element will largely depend on the size or capacity of the water tank 264. Thermostat or temperature detector 294 is disposed in the tank 264 to read or determine the temperature of the water therein. A venting hole 290 may be included to provide pressure relief from within the tank 264.

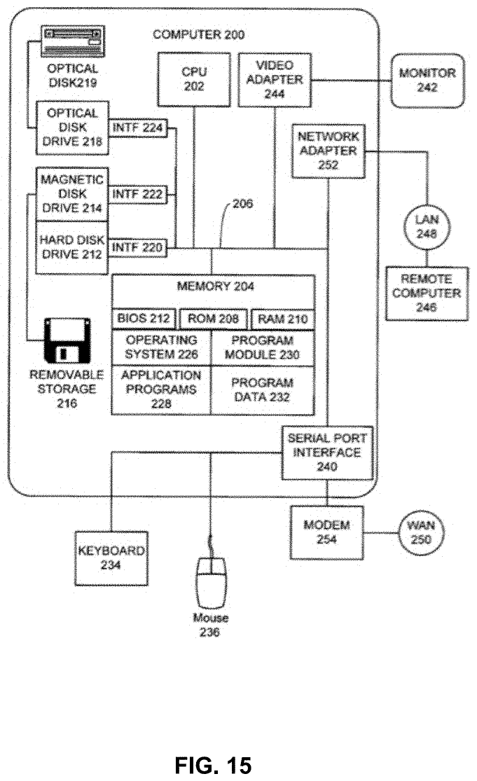

The water pump 296 will pump water from the tank 264 to the shower head 261. Reference character 252 represents the water line section through the wall although it should be noted that instead of fluid connections at 297, the pipe may be continuous. Control device 262 includes one or more computer processors, memory and/or logic to operate the system 260 and method described herein. An example embodiment of computing system used as control device 260 is discussed below in reference to FIG. 15. Control device 262 is connected to the tank 264 via connections c1, c2, c3 and c4. For example, connection c1 connects the control unit or control device 262 to the water heater or heating element 293. Connection c2 connects the control unit or device 262 to the switch or sensor 292, connection c3 connects the control unit or control device 262 with the switch or sensor 291, and connection c4 connects the control unit or control device 262 with the temperature sensor 294. In this manner, the control unit or control device 262 is able to control the operation of these devices and/or receive feedback from these devices in order to operate in its intended function.

It should also be noted that the water tank 264 of at least one embodiment many sit in a tray connected to a drain in order to capture any leakage or water overflow that might develop. In yet another embodiment, the system or shower assembly 260 may also include a water reclamation assembly 280 to receive water from the shower drain, represented as 299, filter the water via a water filtration system 282 and pump the filtered reclaimed water back to the tank 264 via reclamation pump 284. Accordingly, the reclamation assembly 280 of at least one embodiment can drastically reduce the water bill as a result of showering and it can facilitate the process of maintaining a desired level of water in the tank 264 at a preset temperature.

Not shown but may also be included is lighted sign on a stall door to indicate when the cleaning mechanisms are in use for cleaning. A locking latch on the stall door may also prevent the stall door from opening during cleaning operations. Control unit 321 may operate these items.

FIG. 15 illustrates a computer system 200 adapted according to certain embodiments of the control devices 15, 262, and 321. The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of computer system 200. Rather the computer system 200 is provided as an example of one type of computing device that may be adapted to perform the functions of a control device 15, as shown in FIG. 1. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. An automated toilet cleaning system for cleaning a toilet, said automated toilet cleaning system comprising:
at least one cleaning arm assembly movably mounted to a support structure,
at least one cleaning apparatus attached to said at least one cleaning arm assembly,
at least one positioning assembly, wherein said at least one cleaning arm assembly and said at least one cleaning apparatus are movably disposed relative to the support structure via said at least one positioning assembly,
said cleaning arm assembly comprising a biased arm section extendable away from and retractable toward a mounted end of said at least one cleaning arm assembly, and
a spacer arm extending from a portion of said at least one cleaning arm assembly, said spacer arm being disposable in a contacting relation with the toilet, wherein said at least one cleaning apparatus is positionable in a spaced relation from the toilet during at least a portion of a cleaning cycle.

2. The system as recited in claim I wherein said at least one cleaning arm assembly is angularly positionable relative to said support structure via said positioning assembly.

3. The system as recited in claim 2 wherein said biased arm is linearly positionable via a biasing force.

4. The system as recited in claim 3 wherein, with said spacer arm in contact with a portion of the toilet, and as said positioning assembly angularly positions said at least one cleaning arm assembly relative to the support structure, said biased arm section is linearly movable to maintain said at least one cleaning apparatus in said spaced relation from the toilet during at least a portion of the cleaning cycle.

5. The system as recited in claim 4 wherein said spacer arm comprises a roller attached to a distal end, said roller being in contact with the toilet during at least a portion of a cleaning cycle.

6. The system as recited in claim 5 further comprising an inner bowl cleaning arm assembly and an inner bowl cleaning apparatus, said inner bowl cleaning apparatus being connected to said inner bowl cleaning arm assembly.

7. The system as recited in claim 6 wherein said inner bowl cleaning arm assembly comprises a positioning assembly to movably position said inner bowl cleaning apparatus into and out of an interior of the toilet.

8. The system as recited in claim 7 wherein said inner bowl cleaning apparatus is movably disposed in a horizontal direction and a vertical direction via said positioning assembly of said inner bowl cleaning arm assembly.

9. The system as recited in claim 8 further comprising a collection plate disposed at least partially below said at least one cleaning arm assembly, said collection plate comprising a recessed collection area fluidically interconnected with a drain pipe to collect and drain fluids dispelled during the cleaning cycle.

10. The system as recited in claim 9 wherein said support structure comprises a frame, said frame comprising at least one base and at least one upper mounting portion, said at least one cleaning arm assembly being movably mounted to said upper mounting portion of said frame via said at least one positioning assembly.

11. The system as recited in claim 10 wherein said base of said frame is fixedly mountable to a floor, wherein said collection plate is disposable in an at least partially overlying relation with said base of said frame.

12. An automated toilet cleaning system for cleaning a toilet, said automated toilet cleaning system comprising:
an inner bowl cleaning arm assembly movably mounted to a frame,
a cleaning apparatus attached to said inner bowl cleaning arm assembly,
said inner bowl cleaning arm assembly comprising at least one positioning assembly,
wherein said inner bowl cleaning arm assembly and said cleaning apparatus are movably disposed relative to the support structure via said at least one positioning assembly,
wherein said cleaning apparatus of said inner bowl cleaning arm assembly is disposable into and out of an interior bowl portion of the toilet via said at least one positioning assembly,
a collection plate disposed in an at least partially surrounding relation to the toilet, said collection plate comprising a recessed collection area fluidically interconnected with a drain pipe, said frame comprising at least one base mounted to a floor, wherein said collection plate is disposed in an at least partially covering relation to said base.

13. The system as recited in claim 12 further comprising at least one exterior cleaning arm assembly, said at least one exterior cleaning arm assembly comprising a positioning assembly and at least one exterior cleaning apparatus.

14. The system as recited in claim 13 wherein said at least one exterior cleaning arm assembly comprises a biased arm section linearly extendable away from and retractable toward a mounted end of said at least one exterior cleaning arm assembly.

15. The system as recited in claim 14 further comprising a spacer arm extending from a portion of said at least one exterior cleaning arm assembly, said spacer arm being disposable in a contacting relation with an exterior surface of the toilet, wherein said at least one exterior cleaning apparatus is positionable in a spaced relation from the toilet during at least a portion of a cleaning cycle.

16. The system as recited in claim 15 wherein said at least one exterior cleaning arm assembly is angularly positionable relative to said frame via said positioning assembly.

17. The system as recited in claim 16 wherein said biased arm is linearly positionable via a biasing force.

18. The system as recited in claim 17 wherein, with said spacer arm in contact with the exterior surface of the toilet, and as said positioning assembly of said at least one exterior cleaning arm assembly angularly positions said at least one exterior cleaning arm assembly relative to said frame, said biased arm section is linearly movable to maintain said at least one exterior cleaning apparatus in said spaced relation from the toilet during at least a portion of the cleaning cycle.
